(19) United States
(12) Patent Application Publication
(10) Pub. No.: US 2017/0302709 A1
(43) Pub. Date: Oct. 19, 2017

(54) VIRTUAL MEETING PARTICIPANT RESPONSE INDICATION METHOD AND SYSTEM

(71) Applicant: Maria Francisca JONES, Middlesex (GB)

(72) Inventors: Maria Francisca JONES, Middlesex (GB); Alexander JONES, Middlesex (GB)

(21) Appl. No.: 15/642,224

(22) Filed: Jul. 5, 2017

Related U.S. Application Data
(63) Continuation-in-part of application No. 15/395,321, filed on Dec. 30, 2016.

(30) Foreign Application Priority Data
Dec. 31, 2015 (GB) 1523166.5

(51) Int. Cl. H04L 29/06; H04L 12/58

(52) U.S. Cl. CPC H04L 65/403; H04L 51/046; H04L 51/10

(57) ABSTRACT

A method of indicating emotive responses in a virtual meeting, the method comprising creating or select avatar data defining one or more avatars to represent one or more corresponding users in response to input from the one or more corresponding users; receiving one or more user selections of meeting data defining one or more virtual meetings, a user selection comprising an indication that the user is attending the virtual meeting; generating an output for display of a virtual meeting with one or more avatars representing one or more users attending the meeting using the avatar data and the meeting data corresponding to the virtual meeting; receiving emotive input data from one or more users indicative of an emotive response or body language of the one or more users attending the virtual meeting; processing the avatar data using the emotive input data; and updating the output for display of the virtual meeting to render the one or more avatars for the one or more users to display a respective emotive state dependent upon the respective emotive input data.

### RELATED APPLICATIONS

This application is a continuation in part of U.S. patent application Ser. No. 15/395,321 filed on Dec. 30, 2016 and entitled “DIRECT INTEGRATION SYSTEM”, which claims priority to Great Britain application 1523166.5 filed Dec. 31, 2015, the contents of which are hereby incorporated by reference in their entirety.

### FIELD OF THE INVENTION

The present disclosure relates to methods and systems for indicating a response of a participant in a virtual meeting.

### BACKGROUND INFORMATION

For business and social reasons, computer users often arrange meetings, such as formal business meetings or informal gatherings in a virtual environment on a computer-networked system. Such meetings save the costs or travel to meet in person and save travel time. They are also very convenient and enable meetings of diverse and distributed people at short notice.

Virtual meetings can also form the basis of a framework for social interactions between members of a group of users. The interface hosting a virtual meeting can also be used as a means of providing many ancillary functions to accompany the meeting.

In a meeting where people do not meet in person, it is important to try to make the interaction between people in the virtual environment as natural as possible.

### SUMMARY OF THE INVENTION

One aspect of the invention provides a system for indicating emotive responses in a virtual meeting, the system comprising at least one processor; and a memory storing instructions, which instructions being executable by the at least one processor to: create or select avatar data defining one or more avatars to represent one or more corresponding users in response to input from the one or more corresponding users; receive one or more user selections of meeting data defining one or more virtual meetings, a user selection comprising an indication that the user is attending the virtual meeting; generate an output for display of a virtual meeting with one or more avatars representing one or more users attending the meeting using the avatar data and the meeting data corresponding to the virtual meeting; receive emotive input data from one or more users indicative of an emotive response or body language of the one or more users attending the virtual meeting; process the avatar data using the emotive input data; and update the output for display of the virtual meeting to render the one or more avatars for the one or more users to display a respective emotive state dependent upon the respective emotive input data.

Another aspect of the invention provides a method of indicating emotive responses in a virtual meeting, the method comprising creating or select avatar data defining one or more avatars to represent one or more corresponding users in response to input from the one or more corresponding users; receiving one or more user selections of meeting data defining one or more virtual meetings, a user selection comprising an indication that the user is attending the virtual meeting; generating an output for display of a virtual meeting with one or more avatars representing one or more users attending the meeting using the avatar data and the meeting data corresponding to the virtual meeting; receiving emotive input data from one or more users indicative of an emotive response or body language of the one or more users attending the virtual meeting; processing the avatar data using the emotive input data; and updating the output for display of the virtual meeting to render the one or more avatars for the one or more users to display a respective emotive state dependent upon the respective emotive input data.

Another aspect of the invention provides a carrier medium or a storage medium carrying code executable by a processor to carry out the deferred search method.

### BRIEF DESCRIPTION OF THE DRAWINGS

FIG. 1 is a schematic diagram illustrating a system according to one embodiment;

FIG. 2 is a flow diagram of a method using the system of FIG. 1 according to one embodiment;

FIG. 3 is a schematic illustration of a user interface for a virtual conference generated according to one embodiment;

FIG. 4 is a schematic diagram of a meeting using an augmented reality conference display according to one embodiment;

FIG. 5 is a schematic illustration of a user interface for an augmented reality conference display generated in the embodiment of FIG. 4;

FIG. 6 is a schematic illustration of a user interface for a social meeting generated according to one embodiment; and

FIG. 7 is a schematic diagram of a basic computing device for use in one embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the following embodiments, like components are labelled with like reference numerals.

In the following embodiments, data is described as being stored in at least one database. The term database is intended to encompass any data structure (and/or combinations of multiple data structures) for storing and/or organizing data, including, but not limited to, relational databases (e.g., Oracle databases, mySQL databases, etc.), non-relational databases (e.g., NoSQL databases, etc.), in-memory databases, spreadsheets, as comma separated values (CSV) files, eXtendible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) is to be understood as being stored in one or more data stores. A “file system” may control how data is stored and/or retrieved (for example, a disk file system like FAT, NTFS, optical discs, etc., a flash file system, a tape file system, a database file system, a transactional file system, a network file system, etc.). For simplicity, the disclosure is described herein with respect to databases. However, the systems and techniques disclosed herein may be implemented with file systems or a combination of databases and file systems.

In the following embodiments, the term data store is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., solid state drives, random-access memory (RAM), etc.), and/or the like. Another example of a data store is a hosted storage environment that includes a collection of physical data storage devices that may be remotely accessible and may be rapidly provisioned as needed (commonly referred to as “cloud” storage).

The functions or algorithms described herein are implemented in hardware, software or a combination of software and hardware in one embodiment. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

A generalized embodiment provides a method and system for indicating emotive responses in a virtual meeting, in which avatar data defining one or more avatars to represent one or more corresponding users in response to input from the one or more corresponding users is created or selected and one or more user selections of meeting data defining one or more virtual meetings is received. A user selection comprises an indication that the user is attending the virtual meeting. An output is generated for display of a virtual meeting with one or more avatars representing one or more users attending the meeting using the avatar data and the meeting data corresponding to the virtual meeting. Emotive input data is received from one or more users indicative of an emotive response or body language of the one or more users attending the virtual meeting. The avatar data is processed using the emotive input data, and the output for display of the virtual meeting is updated to render the one or more avatars for the one or more users to display a respective emotive state dependent upon the respective emotive input data.

The virtual meeting can be any form of meeting in a virtual environment, such as a business meeting, a conference, a social meeting, a chat room, a virtual shop etc. In other words, any virtual situation where users generate avatars to be present in a virtual situation where other avatars are present. The display of an emotive state in the virtual environment enables interaction with other users via the avatars to indicate emotive states of users. Hence, the emotive state of the avatars can be manipulated simply to reflect the emotive state of the user to simply interact with other users by body language and without requiring text of any other form of indications. Body language in avatars is the most natural form of expression of emotions to other users via the virtual environment.

The virtual meeting can be a ‘pure’ virtual meeting where all of the images of the participants are generated as avatars. Alternatively, the virtual meeting may be an augmented reality meeting in which video images of one or more participants in a meeting are displayed, and the augmented reality meeting has one or more avatars representing one or more users overlaid on the video data with the video images of the participants. In this way, those participants who are not part of the ‘real’ meeting can express themselves and interact using the body language of their avatars.

Interaction input can be received from one or more users attending the virtual meeting to cause the avatars to perform required interaction, and the output for display of the virtual meeting is updated to render the one or more avatars for the one or more users from which interaction data is received to display the required interaction. For example, the interaction can include the emotive interaction of a greeting, including shaking hands, ‘high filing’, hugging or kissing.

The user interface can, in one embodiment, be provided as a conventional web site having a displayed output and a pointer device and keyboard input by a user. In alternative embodiments, the interface can be provided by any form of visual output and any form of input such as keyboard, touch screen, pointer device (such as a mouse, trackball, trackpad, or pen device), audio recognition hardware and/or software to recognize a sounds or speech from a user, gesture recognition input hardware and/or software, etc.

In one embodiment, the method and system can be used with the method and system disclosed in copending U.S. patent application Ser. No. ______, filed on the same date as this application and entitled “VIRTUAL OFFICE”, the content of which is hereby incorporated by reference in its entirety. Thus, the virtual meeting can be part of a virtual office to allow users to control their avatars to interact with images of items of office equipment to cause the items of office equipment to perform office functions.

In one embodiment, the method and system can be used with the method and apparatus disclosed in copending U.S. patent application Ser. No. ______, filed on the same date as this application and entitled “METHOD AND APPARATUS TO TRANSFER DATA FROM A FIRST COMPUTER STATE TO A DIFFERENT COMPUTER STATE”, the content of which is hereby incorporated by reference in its entirety.

In one embodiment, the method and system can be used with the method and apparatus disclosed in copending U.S. patent application Ser. No. ______, filed on the same date as this application and entitled “EVENT BASED DEFERRED SEARCH METHOD AND SYSTEM”, the content of which is hereby incorporated by reference in its entirety.

In one embodiment, the method and system can be used with the method and apparatus disclosed in co-pending U.S. patent application Ser. No. 15/395,343, filed 30 Dec. 2016 and entitled “USER INTERFACE METHOD AND APPARATUS”, the content of which is hereby incorporated in its entirety. The user interface of U.S. Ser. No. 15/395,343 can provide a means by which the user interacts with the system for inputs and selections.

In one embodiment, the method and system can be used with the electronic transaction method and system disclosed in copending U.S. patent application Ser. No. 15/395,487, filed 30 Dec. 2016 and entitled “AN ELECTRONIC TRANSACTION METHOD AND APPARATUS”, the content of which is hereby incorporated in its entirety.

Specific embodiments will now be described with reference to the drawings.

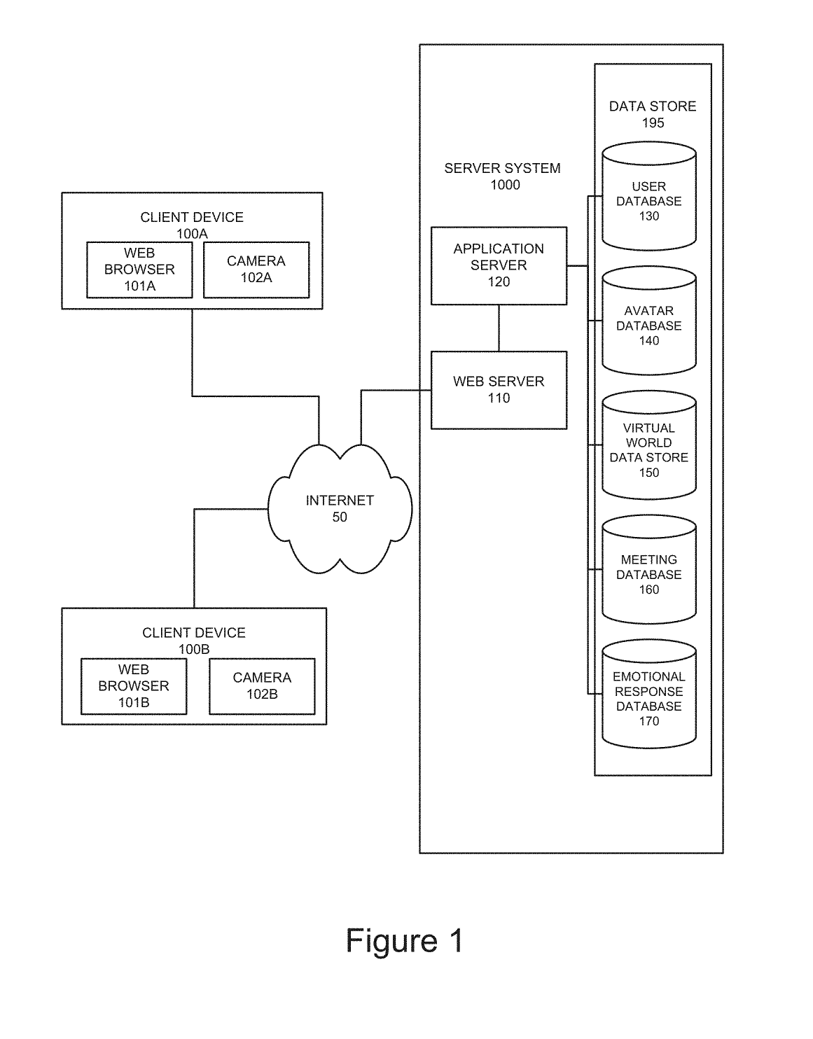

FIG. 1 illustrates a generalized system according to one embodiment.

FIG. 1 illustrates two client devices 100A and 100B, each for use by a user. Any number of client devices may be used. The client devices 100A and 100B can comprise any type of computing or processing machine, such as a personal computer, a laptop, a tablet computer, a personal organizer, a mobile device, smart phone, a mobile telephone, a video player, a television, a multimedia device, personal digital assistant, etc. In this embodiment each client device executes a web browser 101A and 101B to enable it to interact with hosted web pages at a server system 1000. In an alternative embodiment, the web browser 101A and 101B can be replaced by an application running on the client devices 100A and 100B.

The client devices 100A and 100B are connected to a network, which is this example is the internet 50. The network can comprise any suitable communications network for networking computer devices.

The server system 1000 comprises any number of server computers connected to the internet 50. The server system 1000 operates to provide the service according to embodiments of the invention. The server system 1000 comprises a web server 110 to host web pages to be accessed and rendered by the browsers 101A and 101B. An application server 120 is connected to the web server 110 to provide dynamic data for the web server 110. The application server 120 is connected to a data store 195. The data store 195 stores data in a number of different databases, namely a user database 130, an avatar database 140, a virtual world data store 150, a meeting database 160, and an emotional response database 170. The user database 130 stores information on the user, which can include an identifier, name, age, username and password, date of birth, address, etc. The avatar database 140 can store data on avatars available to be created by users to represent themselves and the user generated avatars associated with the user data. The virtual world data store 150 stores data required to create the virtual meeting environments. The meeting database 160 can store data on specific meetings, including a meeting identifier, a meeting name, associated users attending the meeting (hence indirectly the avatars to be rendered in the virtual meeting), an identifier for any video stream to be rendered as part of an augmented reality virtual meeting, meeting date, meeting login information, etc. The emotional response database 170 can store data indicative of a set of emotional responses that can be selected by a user and used to modify the rendered appearance of the avatars. The avatar data and processing for rendering in the virtual environment can be structured to allow each of the emotional responses to be applied. The emotional responses can be such things as: smile, laugh, cry, greet by handshake, hug or kiss, bored, frown, cross angry, amazed, relaxed, interested/a look of intent, etc.

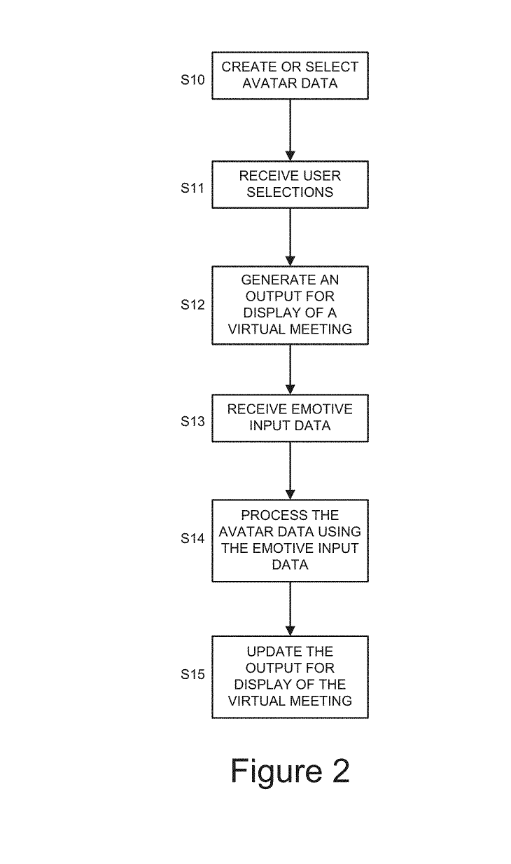

FIG. 2 is a flow diagram of a process for indicating emotive responses in a virtual meeting using the system of FIG. 1 according to one embodiment.

In step S10 a user creates or selects an avatar to represent them in a virtual meeting. In step S11 a user selection of meeting data defining a virtual meeting is received. A user selection comprises an indication that the user is attending the virtual meeting. In step S12 an output for display of the virtual meeting is generated with an avatar representing the users attending the meeting using the avatar data and the meeting data corresponding to the virtual meeting. In step S13 emotive input data is received from the user indicative of an emotive response or body language of the user attending the virtual meeting. In step S14 the avatar data is processed using the emotive input data and in step S15 the output for display of the virtual meeting is updated to render the avatar for the user to display an emotive state dependent upon the emotive input data.

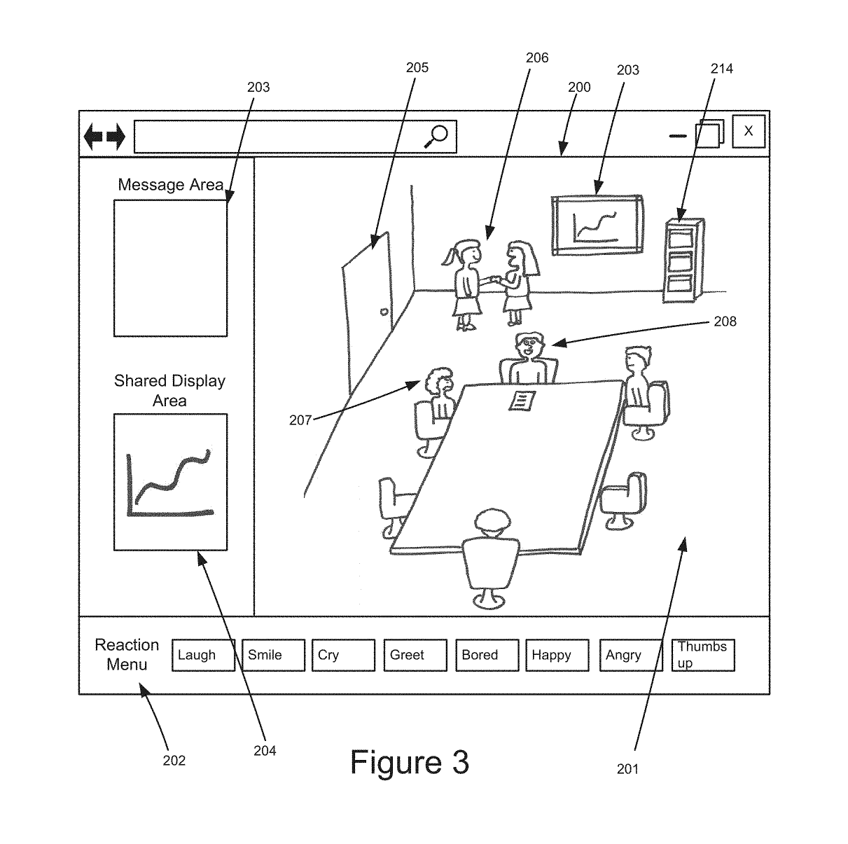

FIG. 3 is a schematic illustration of a user interface for a virtual conference generated according to one embodiment.

The display 200 includes a virtual conference area 201 to display the virtual conference and a reaction menu area 202 displaying user selectable menu items to enable a user to select to input an emotions response or body language to be applied to their avatar in the virtual conference for interaction with other attendees. The other attendees will be able to see the user's emotional reaction as applied to their avatar in the virtual conference display area enabling them to react accordingly, for example by changing the emotive response displayed by their own avatar or by taking some other action in the virtual conference. Although in this embodiment, the menu is illustrated as a text menu, the menu could comprise icons or images depicting various emotional states that the user can select to modify their avatar's appearance and behaviour to display the emotional response and body language according to the user's selection.

A menu could also be displayed to a user to allow a user to select sounds or music that the avatar could output in the virtual conference e.g. selected wording or readymade phrases like’ ‘greetings’, ‘hey’, ‘what's up?’ or a birthday or greeting messages that could be ready made or composable by the user. These could be selectable in different accents, such as American or English or even an impersonation of a famous person.

There could be a translation option which translates and replays a message, such as part of what the user wants to say, e.g. speak French when being Romanic. This can be a pre-saved recording or the system may translate what user (avatar) has just said, although it may be a bit delayed. In one example, there is a prerecorded and saved message option to use where the user is able to record and play back, via their avatar as, for example, a response to another avatar or guest user that they are meeting.

The display 200 includes outside the area 201 for the virtual conference a shared message area 203 that can be used to share messages with any other user individually, in groups or globally to the virtual conference attendees. Also, outside the area 201 for the virtual conference, a shared display area 204 is displayed. In this example, it corresponds to a virtual white board 203 in the virtual conference so that anything drawn on the shared display area will appear on the virtual white board 203.

In the virtual conference area 201 there are displayed avatars of attendees of the meeting. Four are seated. Two attendees 206 are shown greeting each other by shaking hands. To achieve this, the users corresponding to the avatars 206 have selected a reaction menu item to shake hands. One avatar 207 for a user is shown displaying anger. One avatar 208 is shown smiling.

The virtual conference can be controlled to operate as a conventional conference, with each user of a client device being able to speak to input audio for transmission to the client devices of the other attendees. In one example, documents can be entered into the meeting by placing them on the table in the virtual display. The location of the placement will effect who can see them. To show them to everyone, copies of the document may be placed before everyone. Documents can be dragged into a virtual filing cabinet 214 to file them, or the user can select to find or a file in the virtual filing cabinet 214 or search the virtual filing cabinet 214 to cause a filing system to be searched to find documents. Users can make their avatars move in the virtual conference and when they leave the conference, they can be shown exiting through a door 205.

The perspective displayed of the virtual conference for each attendee can vary depending upon their assigned seating position around the table.

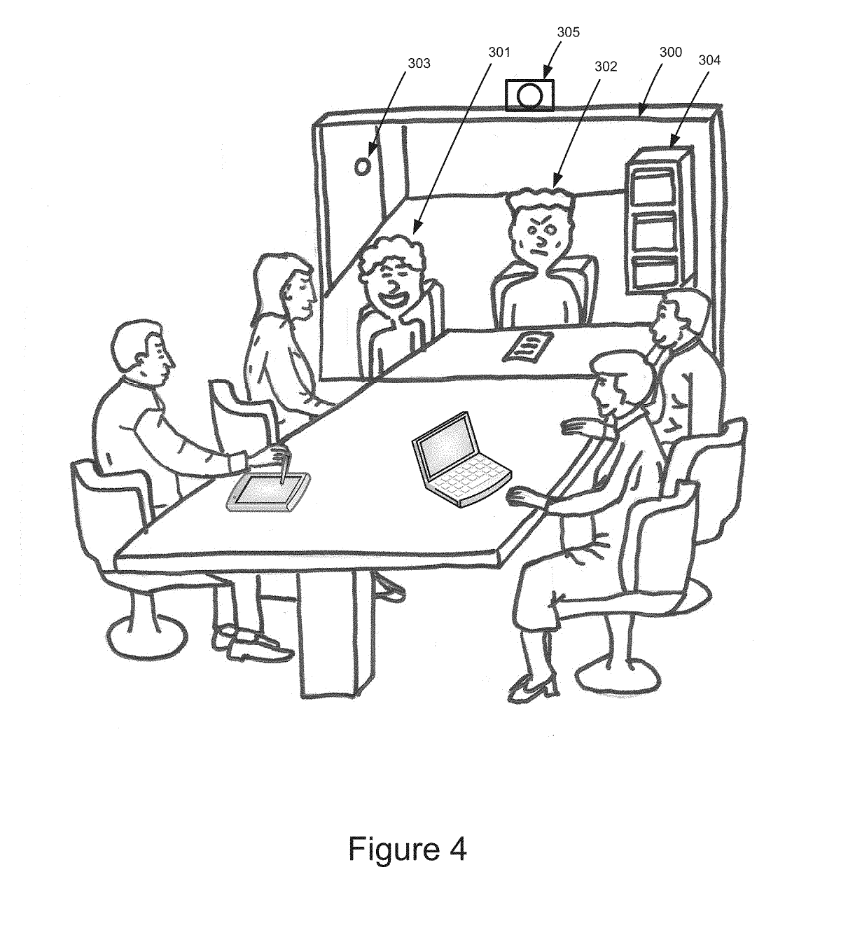

FIG. 4 is a schematic diagram of a meeting using an augmented reality conference display according to one embodiment.

In the foreground, a physical real world conference is taking place around a table with four participants. At the end of the table is a display 300 displaying participants attending virtually using their avatars 301 and 302. The avatar 301 has been controlled by its respective user by an emotive input to reflect a happy or smiley face. The avatar 302 has been controlled by its respective user by an emotive input to reflect an angry or annoyed face.

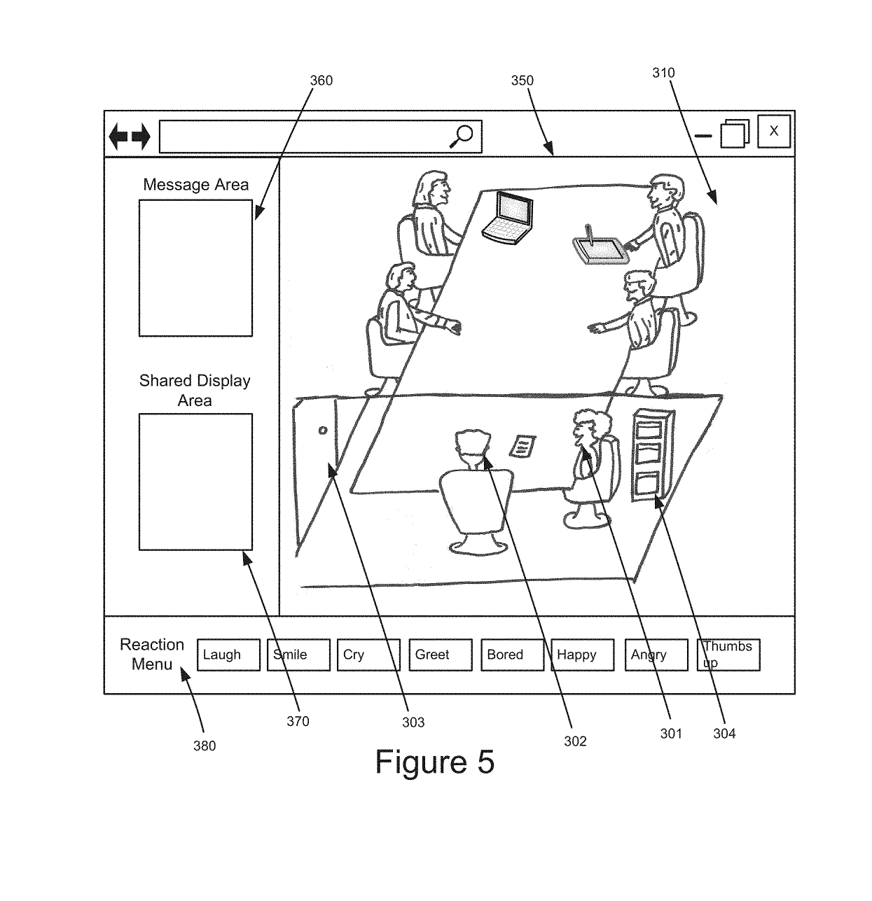

The augmented reality conference can be controlled to operate as a conventional conference, with each user of a client device being able to speak to input audio for transmission to the client devices of the other attendees and to speakers associated with the display 300. In one example, documents can be entered into the meeting by placing them on the table in the virtual display 300. The location of the placement can effect who can see them. To show them to everyone, copies of the document need to be placed before everyone. In one example, documents can be dragged into a virtual filing cabinet 304 to file them. Users can make their avatars move in the virtual conference and when they leave the conference, they can be shown exiting through a door 303. A video camera or webcam 305 is provided to provide a video feed of the real attendees to the remote or virtual attendees' computers, as shown in FIG. 5.

FIG. 5 is a schematic illustration of a user interface for an augmented reality conference display generated for a virtual attendee of the embodiment of FIG. 4

The display 350 includes an augmented reality conference area 310 to display the augmented reality conference comprising a video stream of the physical attendees and a virtual conference segment conjoined. A reaction menu area 380 displays user selectable menu items to enable the user to select to input an emotional response or body language to be applied to their avatar in the augmented reality conference for interaction with other attendees. The other attendees will be able to see the user's emotional and physical reaction as applied to their avatar in the augmented reality conference display area enabling them to react accordingly, for example by changing the emotive response displayed by their own avatar or by taking some other action in the augmented reality conference. Although in this embodiment, the menu is illustrated as a text menu, the menu could comprise icons or images depicting various emotional states that the user can select to modify their avatar's appearance and behaviour to display the emotional response and body language according to the user's selection.

In on example, a user can select to share music data, which assists in displaying a user's mood, or expression of emotion, or it can be used in response to another users response e.g. to play, share, or save or to enjoy the tune or song, e.g. a happy song to share with other user (avatar). A user's mood can be displayed by playing saved or selected music e.g. sad music for feeling down, sad lonely, or blue, or happy music in that they are feeling good. Also, in one example, a use is able to tune into a radio station and find a tune that is apt for the user's emotion at the time.

Also, in one example, a user is to be able to select and apply colors (Chronotherapy, sometimes called colour therapy) e.g. virtual paint in different colors. A user may select to paint a virtual bedroom in a magical sparkly colour, or a deep dark colour to show friends how the user is feeling in the users virtual space.

The augmented reality conference can be controlled to operate as a conventional conference, with each user of a client device attending the virtual conference segment being able to speak to input audio for transmission to the client devices of the other virtual attendees and to the speaker associated with the display 300 for the physical (real) attendees. In one example, documents that are physically entered into the real conference can be entered into the virtual conference by placing them on the table in the virtual display segment of the augmented reality conference. The location of the placement will effect who can see them. To show them to everyone in the virtual segment of the augmented reality conference, copies of the document can be placed before every virtual attendee. Documents can be dragged into a virtual filing cabinet 304 to file them. Users can make their avatars move in the virtual segment of the augmented reality conference and when they leave the conference, they can be shown exiting through a door 3.

The display 350 includes a shared message area 360 that can be used to share messages with any other user individually, in groups or globally to the augmented reality conference attendees. Also, a shared display area 370 is displayed.

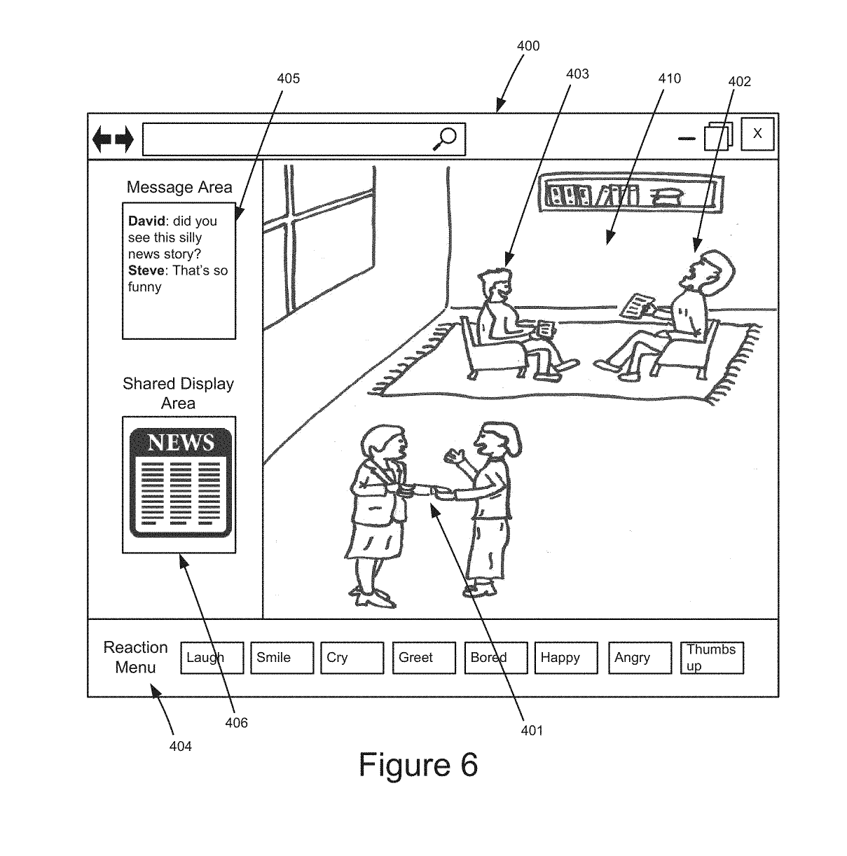

FIG. 6 is a schematic illustration of a user interface for a social meeting generated according to one embodiment.

A display 400 includes a virtual meeting area 410 in which avatars can be displayed in a virtual environment. In this embodiment, avatar 403 has been controlled by its user to smile, avatar 402 has been controlled to laugh and the two avatars 401 in the foreground have been controlled to greet each other by shaking hands.

A reaction menu area 404 displays user selectable menu items to enable a user to select to input an emotional response or body language to be applied to their avatar in the virtual meeting for interaction with other attendees. The other attendees will be able to see the user's emotional reaction as applied to their avatar in the virtual meeting display area 410 enabling them to react accordingly, for example by changing the emotive response displayed by their own avatar or by taking some other action in the virtual meeting.

The display 400 includes outside the area 410 for the virtual meeting a shared message area 405 that can be used to share messages with any other user individually, in groups or globally to the virtual meeting attendees. Also, outside the area 410 for the virtual meeting, a shared display area 406 is displayed. In this example, it corresponds to a news item shared between the two users represented by the avatars 402 and 403. The message area displays a private message exchange between avatar 403 (David) and avatar 402 (Steve) related to the news item. The avatars emotional response has been adjusted by input by the associated users to reflect their interaction regarding the news item.

The system can be controlled to allow users to join and move between meetings that take place in different rooms. These rooms could be displayed schematically as, for example, a room map to allow a user to select to move from one room to another to join and leave a meeting. The rooms can represent different types of meetings e.g. a games room meeting, a coffee table meeting etc. Also users can set up meetings and invite other users to the meetings with the virtual location and time of the meeting being set by the inviting user.

In the displayed area of the meeting, identifiers of the avatars can be displayed or alternatively or in addition, a list of attendees can be displayed.

The virtual meeting using avatars could be in the environment related to any corresponding real world environment, such as in a shop, or in a gym.

In the embodiments described above, the user input to set the emotional state of the avatar is based on a simple menu selection. However, other forms of user input can be used. For example, a camera can be provided to take a picture or video of a user's face and possibly body and determine an emotional response of the user. Also, the user could be provided with the ability to input free text by typing or by recognition of speech to describe their emotional response to control their avatar. The picture or video of the user could also be used to capture the user's current clothing and to adapt the avatar to represent the different cloths worn by the user, e.g. outfits, a suit and tie, a dress, fancy dress etc. This can be used to facilitate the user's ability to dress smart or casual in a virtual meeting. A user can choose a dress to wear or a suit and tie which can be changed for each meeting, e.g. a different colour tie.

The avatar generated can be selected by the user to take any form. For example, the avatar could be an animal with the user's own features included or any other character mixed in with the user's i.e. human features which can be adapted.

This would suit different age groups as the environment for the meeting can be chosen as desired by the user or group of users. Groups of old and young people e.g. a family or social group, e.g. gran in Ireland meeting up virtually with young grandchild in Australia to be able to share a story and have a giggle. Users can choose casual dress to suit or match the virtual environment, or the virtual environment can change to match the selected outfit. Users can enjoy virtual accessories and items to meet their needs within the virtual meeting, which they could buy from a virtual shop, go into a virtual changing room, and then they are ready for the next virtual meeting.

A user can select for example from a menu whether to join another virtual meeting in another virtual meeting room.

In one example, the virtual meeting is in a virtual restaurant or a social gathering involving virtual food and/or drink.

### Basic Computing Device

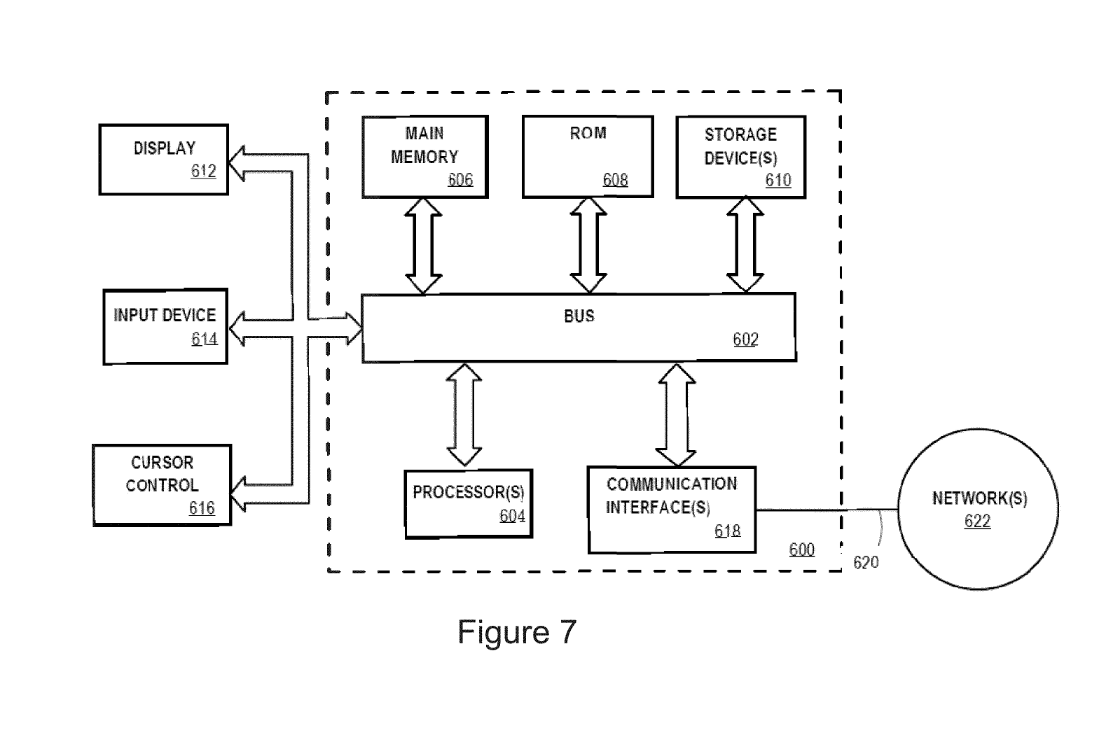

FIG. 7 is a block diagram that illustrates a basic computing device 600 in which the example embodiment(s) of the present invention may be embodied. Computing device 600 and its components, including their connections, relationships, and functions, is meant to be exemplary only, and not meant to limit implementations of the example embodiment(s). Other computing devices suitable for implementing the example embodiment(s) may have different components, including components with different connections, relationships, and functions.

The computing device 600 can comprise any of the servers or the user device as illustrated in FIG. 1 for example.

Computing device 600 may include a bus 602 or other communication mechanism for addressing main memory 606 and for transferring data between and among the various components of device 600.

Computing device 600 may also include one or more hardware processors 604 coupled with bus 602 for processing information. A hardware processor 604 may be a general purpose microprocessor, a system on a chip (SoC), or other processor.

Main memory 606, such as a random access memory (RAM) or other dynamic storage device, also may be coupled to bus 602 for storing information and software instructions to be executed by processor(s) 604. Main memory 606 also may be used for storing temporary variables or other intermediate information during execution of software instructions to be executed by processor(s) 604.

Software instructions, when stored in storage media accessible to processor(s) 604, render computing device 600 into a special-purpose computing device that is customized to perform the operations specified in the software instructions. The terms “software”, “software instructions”, “computer program”, “computer-executable instructions”, and “processor-executable instructions” are to be broadly construed to cover any machine-readable information, whether or not human-readable, for instructing a computing device to perform specific operations, and including, but not limited to, application software, desktop applications, scripts, binaries, operating systems, device drivers, boot loaders, shells, utilities, system software, JAVASCRIPT, web pages, web applications, plugins, embedded software, microcode, compilers, debuggers, interpreters, virtual machines, linkers, and text editors.

Computing device 600 also may include read only memory (ROM) 608 or other static storage device coupled to bus 602 for storing static information and software instructions for processor(s) 604.

One or more mass storage devices 610 may be coupled to bus 602 for persistently storing information and software instructions on fixed or removable media, such as magnetic, optical, solid-state, magnetic-optical, flash memory, or any other available mass storage technology. The mass storage may be shared on a network, or it may be dedicated mass storage. Typically, at least one of the mass storage devices 610 (e.g., the main hard disk for the device) stores a body of program and data for directing operation of the computing device, including an operating system, user application programs, driver and other support files, as well as other data files of all sorts.

Computing device 600 may be coupled via bus 602 to display 612, such as a liquid crystal display (LCD) or other electronic visual display, for displaying information to a computer user. In some configurations, a touch sensitive surface incorporating touch detection technology (e.g., resistive, capacitive, etc.) may be overlaid on display 612 to form a touch sensitive display for communicating touch gesture (e.g., finger or stylus) input to processor(s) 604.

An input device 614, including alphanumeric and other keys, may be coupled to bus 602 for communicating information and command selections to processor 604. In addition to or instead of alphanumeric and other keys, input device 614 may include one or more physical buttons or switches such as, for example, a power (on/off) button, a “home” button, volume control buttons, or the like.

Another type of user input device may be a cursor control 616, such as a mouse, a trackball, a cursor, a touch screen, or direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane. Other input device embodiments include an audio or speech recognition input module to recognize audio input such as speech, a visual input device capable of recognizing gestures by a user, and a keyboard.

While in some configurations, such as the configuration depicted in FIG. 7, one or more of display 612, input device 614, and cursor control 616 are external components (i.e., peripheral devices) of computing device 600, some or all of display 612, input device 614, and cursor control 616 are integrated as part of the form factor of computing device 600 in other configurations.

In addition to or in place of the display 612 any other form of user output device can be sued such as an audio output device or a tactile (vibrational) output device.

Functions of the disclosed systems, methods, and modules may be performed by computing device 600 in response to processor(s) 604 executing one or more programs of software instructions contained in main memory 606. Such software instructions may be read into main memory 606 from another storage medium, such as storage device(s) 610 or a transmission medium. Execution of the software instructions contained in main memory 606 cause processor(s) 604 to perform the functions of the example embodiment(s).

While functions and operations of the example embodiment(s) may be implemented entirely with software instructions, hard-wired or programmable circuitry of computing device 600 (e.g., an ASIC, a FPGA, or the like) may be used in other embodiments in place of or in combination with software instructions to perform the functions, according to the requirements of the particular implementation at hand.

The term “storage media” as used herein refers to any non-transitory media that store data and/or software instructions that cause a computing device to operate in a specific fashion. Such storage media may comprise non-volatile media and/or volatile media. Non-volatile media includes, for example, non-volatile random access memory (NVRAM), flash memory, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, flash memory, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications. A machine readable medium carrying instructions in the form of code can comprise a non-transient storage medium and a transmission medium.

Various forms of media may be involved in carrying one or more sequences of one or more software instructions to processor(s) 604 for execution. For example, the software instructions may initially be carried on a magnetic disk or solid-state drive of a remote computer. The remote computer can load the software instructions into its dynamic memory and send the software instructions over a telephone line using a modem. A modem local to computing device 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor(s) 604 retrieves and executes the software instructions. The software instructions received by main memory 606 may optionally be stored on storage device(s) 610 either before or after execution by processor(s) 604.

Computing device 600 also may include one or more communication interface(s) 618 coupled to bus 602. A communication interface 618 provides a two-way data communication coupling to a wired or wireless network link 620 that is connected to a local network 622 (e.g., Ethernet network, Wireless Local Area Network, cellular phone network, Bluetooth wireless network, or the like). Communication interface 618 sends and receives electrical, electromagnetic, or optical signals that carry digital data streams representing various types of information. For example, communication interface 618 may be a wired network interface card, a wireless network interface card with an integrated radio antenna, or a modem (e.g., ISDN, DSL, or cable modem).

Network link(s) 620 typically provide data communication through one or more networks to other data devices. For example, a network link 620 may provide a connection through a local network 622 to a host computer or to data equipment operated by an Internet Service Provider (ISP). ISP in turn provides data communication services through the world wide packet data communication network now commonly referred to as the “Internet”. Local network(s) 622 and Internet use electrical, electromagnetic or optical signals that carry digital data streams. The signals through the various networks and the signals on network link(s) 620 and through communication interface(s) 618, which carry the digital data to and from computing device 600, are example forms of transmission media.

Computing device 600 can send messages and receive data, including program code, through the network(s), network link(s) 620 and communication interface(s) 618. In the Internet example, a server might transmit a requested code for an application program through Internet, ISP, local network(s) 622 and communication interface(s) 618.

The received code may be executed by processor 604 as it is received, and/or stored in storage device 610, or other non-volatile storage for later execution.

One aspect provides a carrier medium, such as a non-transient storage medium storing code for execution by a processor of a machine to carry out the method, or a transient medium carrying processor executable code for execution by a processor of a machine to carry out the method. Embodiments can be implemented in programmable digital logic that implements computer code. The code can be supplied to the programmable logic, such as a processor or microprocessor, on a carrier medium. One such embodiment of a carrier medium is a transient medium i.e. a signal such as an electrical, electromagnetic, acoustic, magnetic, or optical signal. Another form of carrier medium is a non-transitory storage medium that stores the code, such as a solid-state memory, magnetic media (hard disk drive), or optical media (Compact disc (CD) or digital versatile disc (DVD)).

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A system for indicating emotive responses in a virtual meeting, the system comprising:
at least one processor; and
a memory storing instructions, which instructions being executable by the at least one processor to:
create or select avatar data defining one or more avatars to represent one or more corresponding users in response to input from the one or more corresponding users;
receive one or more user selections of meeting data defining one or more virtual meetings, a user selection comprising an indication that the user is attending the virtual meeting;
generate an output for display of a virtual meeting with one or more avatars representing one or more users attending the meeting using the avatar data and the meeting data corresponding to the virtual meeting;
receive emotive input data from one or more users indicative of an emotive response or body language of the one or more users attending the virtual meeting;
process the avatar data using the emotive input data; and
update the output for display of the virtual meeting to render the one or more avatars for the one or more users to display a respective emotive state dependent upon the respective emotive input data.

2. A system according to claim 1, wherein the instructions comprise instructions executable by the at least one processor to render the one or more avatars to display body language associated with the emotive input data.

3. A system according to claim 1, including instructions executable by the at least one processor to receive video data for a meeting, wherein the video data includes video images of one or more participants in a meeting, and the instructions executable by the at least one processor to generate the output for display comprise instructions executable by the at least one processor to generate the output for display as an augmented reality meeting with one or more avatars representing one or more users overlaid on the video data with the video images of the participants.

4. A system according to claim 1, including instructions executable by the at least one processor to store a predefined set of emotive states, wherein instructions executable by the at least one processor to receive the emotive input data comprise instructions to receive the emotive input data as a selection of an output for display of a menu of the emotive states.

5. A system according to claim 1, including instructions executable by the at least one processor to receive interaction input from one or more users attending the virtual meeting to cause the avatars to perform required interaction, and to update the output for display of the virtual meeting to render the one or more avatars for the one or more users from which interaction data is received to display the required interaction.

6. A method of indicating emotive responses in a virtual meeting, the method comprising:
creating or select avatar data defining one or more avatars to represent one or more corresponding users in response to input from the one or more corresponding users;
receiving one or more user selections of meeting data defining one or more virtual meetings, a user selection comprising an indication that the user is attending the virtual meeting;
generating an output for display of a virtual meeting with one or more avatars representing one or more users attending the meeting using the avatar data and the meeting data corresponding to the virtual meeting;
receiving emotive input data from one or more users indicative of an emotive response or body language of the one or more users attending the virtual meeting;
processing the avatar data using the emotive input data; and
updating the output for display of the virtual meeting to render the one or more avatars for the one or more users to display a respective emotive state dependent upon the respective emotive input data.

7. A method according to claim 6, wherein the one or more avatars are rendered to display body language associated with the emotive input data.

8. A method according to claim 6, including receiving video data for a meeting, wherein the video data includes video images of one or more participants in a meeting, and the output is generated for display as an augmented reality meeting with one or more avatars representing one or more users overlaid on the video data with the video images of the participants.

9. A method according to claim 6, including storing a predefined set of emotive states, wherein the emotive input data is received as a selection of an output for display of a menu of the emotive states.

10. A method according to claim 6, including receiving interaction input from one or more users attending the virtual meeting to cause the avatars to perform required interaction, and updating the output for display of the virtual meeting to render the one or more avatars for the one or more users from which interaction data is received to display the required interaction.

11. A non-transient storage medium storing processor executable code for execution by a processor to:
create or select avatar data defining one or more avatars to represent one or more corresponding users in response to input from the one or more corresponding users;
receive one or more user selections of meeting data defining one or more virtual meetings, a user selection comprising an indication that the user is attending the virtual meeting;
generate an output for display of a virtual meeting with one or more avatars representing one or more users attending the meeting using the avatar data and the meeting data corresponding to the virtual meeting;
receive emotive input data from one or more users indicative of an emotive response or body language of the one or more users attending the virtual meeting;
process the avatar data using the emotive input data; and
update the output for display of the virtual meeting to render the one or more avatars for the one or more users to display a respective emotive state dependent upon the respective emotive input data.
